(19) United States
(12) Patent Application Publication
(10) Pub. No.: US 2026/0337313 A1
(43) Pub. Date: Oct. 29, 2026

(54) DIRECT ETHYLENE INJECTION FOR DUAL REACTOR SOLUTION PROCESS

(71) Applicant: Dow Global Technologies LLC, Midland, MI (US)

(72) Inventors: Smita Agrawal, Lake Jackson, TX (US); Anthony J. Castelluccio, Lake Jackson, TX (US); Alec Y. Wang, Sugar Land, TX (US); Pradeep Jain, Missouri City, TX (US); Michael J. Zogg, JR., Houston, TX (US); Lanhe Zhang, Manvel, TX (US); Rajen M. Patel, Missouri City, TX (US); Dibyaranjan Mekap, Pearland, TX (US); Tanner C. Schodowski, Pearland, TX (US)

(73) Assignee: Dow Global Technologies LLC, Midland, MI (US)

(21) Appl. No.: 19/145,113

(22) PCT Filed: Dec. 28, 2023
(86) PCT No.: PCT/US2023/086138

§ 371 Date: Jul. 1, 2025

Related U.S. Application Data
(60) Provisional application No. 63/478,275, filed on Jan. 3, 2023.

(51) Int. Cl. C08F 210/16

(52) U.S. Cl. CPC C08F 210/16

(57) ABSTRACT

Embodiments of the present method of producing ethylene-based polymer comprising first and second polymer fractions comprise reacting ethylene monomer and optionally C₃-C₁₂ α-olefin comonomer in a first solvent in the presence of a first catalyst in a first solution polymerization reactor to produce the first polymer fraction. The method may further comprise reacting the first polymer fraction, a second catalyst, and a second feed comprising ethylene monomer, optionally C₃-C₁₂ α-olefin comonomer, and optionally hydrogen in a second solution polymerization reactor to produce a second polymer fraction. The second feed may be substantially free of solvent. The method may further comprise outputting effluent from the second solution polymerization reactor, wherein the effluent comprises the ethylene-based polymer having the first and second polymer fractions.

### CROSS-REFERENCE TO RELATED APPLICATIONS

This application claims the benefit of U.S. Provisional Application Ser. No. 63/478,275 filed Jan. 3, 2023, the entire disclosure of which is hereby incorporated herein by reference.

### TECHNICAL FIELD

The present specification generally relates to ethylene-based polymer, and in particular, relates to an improved polymerization process producing a low melt-index polymer.

### BACKGROUND

Solution polymerization processes to produce ethylene-based polymer (e.g., LLDPE) utilize hydrocarbon solvent in their reactors to carry out single, liquid-phase polymerization reactions. The solvent plays the roles of dissolving the polymer and ethylene gas to provide the single, liquid-phase environment for polymerization reaction while removing some of the heat of reaction. The polymer concentration exiting the reactor section, or from another perspective, the amount of solvent used for making each product, dictates the maximum total polymer production rate as the plant throughput is limited by the total solvent de-volatilization capacity of the back-end equipment. Therefore, any process improvement that leads to reduced solvent usage would help boost total plant capacity.

Conventionally, ethylene monomer is dissolved in solvent and comonomer, and fed as a single, liquid-phase feed stream to ensure a consistent reactor feed, yet a single, liquid-phase feed dictates that a lot of solvent is needed to totally dissolve the fresh ethylene. As a result, the reactor polymer concentration is limited and the plant capacity is thereby also limited. In multiple reactor configurations, traditionally, this single liquid-phase stream is fed to each reactor.

Producing very low melt index (MI) and/or high molecular weight (Mw) components in the 1^{st} reactor of a multiple reactor configuration can yield excellent dart drop properties. However, it may not be feasible to process such a polymer in a dual loop reactor because the low MI and/or high Mw component may lead to excessively high viscosity in the loop reactor.

Very low MI and/or very high Mw components may be made in a continuously stirred tank reactor (CSTR)/loop dual reactor because a CSTR operates at a much lower percent polymer and higher percent solvent. However, since the CSTR operates at a high percent solvent, such a process would have a lower overall polymer percentage unless solvent was removed before feeding polymer to the second reactor. Such a low overall polymer percentage would result in relatively low production rates for the plant.

Thus, there is a continual need for improved polymerization processes that can produce ethylene-based polymers at high rates, such as very low MI and/or high molecular weight ethylene-based polymers.

### SUMMARY

Embodiments of the present disclosure meet this need for improved output of low melt index ethylene-based polymer by applying a direct ethylene injection system to provide an ethylene feed to the second reactor, which is substantially free of solvent. It is believed that this lack of solvent in the second reactor feed allows the first reactor to produce a high Mw and low melt index polymer without being constrained by viscosity. The lack of solvent in the second reactor feed raises overall polymer concentration, reduces overall solvent load, and subsequently helps boost production rate for existing dual reactor polymerization systems.

According to one embodiment, a method of producing ethylene-based polymer comprising first and second polymer fractions is provided. The method comprises reacting ethylene monomer and optionally C₃-C₁₂ α-olefin comonomer in a first solvent in the presence of a first catalyst in a first solution polymerization reactor to produce the first polymer fraction. The method further comprises reacting the first polymer fraction, a second catalyst, and a second feed comprising ethylene monomer, optionally C₃-C₁₂ α-olefin comonomer, and optionally hydrogen in a second solution polymerization reactor to produce a second polymer fraction, wherein the second feed is substantially free of solvent. Effluent from the second solution polymerization reactor is then outputted, wherein the effluent comprises the ethylene-based polymer having the first and second polymer fractions.

Additional features and advantages will be set forth in the detailed description which follows, and in part will be readily apparent to those skilled in the art from that description or recognized by practicing the embodiments described herein, including the drawings, the detailed description which follows and the claims.

### BRIEF DESCRIPTION OF THE DRAWINGS

FIG. 1 is a schematic illustration of the present series dual reactor polymerization process according to one or more embodiments of the present disclosure.

### DETAILED DESCRIPTION

Specific embodiments of the present application will now be described. The disclosure may, however, be embodied in different forms and should not be construed as limited to the embodiments set forth in this disclosure. Rather, these embodiments are provided so that this disclosure will be thorough and complete, and will fully convey the scope of the subject matter to those skilled in the art.

### Definitions

The term “polymer” refers to a polymeric compound prepared by polymerizing monomers, whether of the same or a different type. The generic term polymer thus embraces the term “homopolymer,” usually employed to refer to polymers prepared from only one type of monomer as well as “copolymer” which refers to polymers prepared from two or more different monomers. The term “interpolymer,” as used herein, refers to a polymer prepared by the polymerization of at least two different types of monomers. The generic term “interpolymer” thus includes copolymers, and polymers prepared from more than two different types of monomers, such as terpolymers.

“Polyethylene” or “ethylene-based polymer” shall mean polymers comprising greater than 50% by mol of units, which have been derived from ethylene monomer. This includes polyethylene homopolymers or copolymers (meaning units derived from ethylene and one or more comonomers). Comonomers may include olefin comonomers as well as polar comonomers. Common forms of polyethylene known in the art include Low Density Polyethylene (LDPE); Linear Low Density Polyethylene (LLDPE); Ultra Low Density Polyethylene (ULDPE); Very Low Density Polyethylene (VLDPE); single-site catalyzed Linear Low Density Polyethylene, including both linear and substantially linear low density resins (m-LLDPE); Medium Density Polyethylene (MDPE); and High Density Polyethylene (HDPE).

The term “LLDPE”, includes resins made using Ziegler-Natta catalyst systems as well as resins made using single-site catalysts, including, but not limited to, bis-metallocene catalysts (sometimes referred to as “m-LLDPE”) and constrained geometry catalysts, and resin made using post-metallocene, molecular catalysts. LLDPE includes linear, substantially linear or heterogeneous polyethylene copolymers or homopolymers. LLDPEs contain less long chain branching than LDPEs and includes the substantially linear ethylene polymers which are further defined in U.S. Pat. Nos. 5,272,236, 5,278,272, 5,582,923 and 5,733,155; the homogeneously branched linear ethylene polymer compositions such as those in U.S. Pat. No. 3,645,992; the heterogeneously branched ethylene polymers such as those prepared according to the process disclosed in U.S. Pat. No. 4,076,698; and/or blends thereof (such as those disclosed in U.S. Pat. No. 3,914,342 or 5,854,045).

The terms “comprising,” “including,” “having,” and their derivatives, are not intended to exclude the presence of any additional component, step or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term, “consisting essentially of” excludes from the scope of any succeeding recitation any other component, step or procedure, excepting those that are not essential to operability. The term “consisting of” excludes any component, step or procedure not specifically delineated or listed.

### EMBODIMENTS

Embodiments of the present disclosure are directed to a method of producing ethylene-based polymer comprising first and second polymer fractions. The first and second polymer fractions may have optimal properties, such as weight-averaged molecular weight (Mw), melt index (I₂), density, melt index ratio (I₂₁/I₂), and molecular weight distribution. These properties may be achieved at acceptable production rates by eliminating the feed of solvent to the second reactor in a two reactor system.

### The First Feed

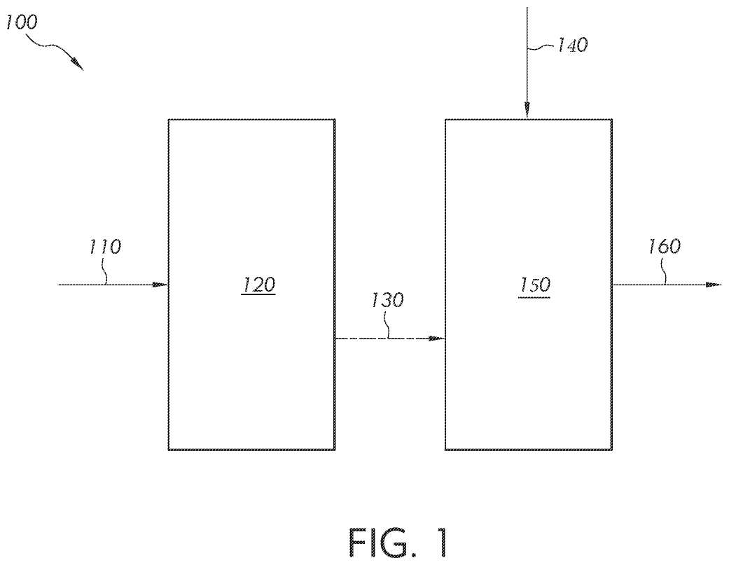

As depicted in FIG. 1, the method may comprise introducing a first feed 110 to a first solution polymerization reactor 120. The first feed may comprise a first ethylene monomer and optionally C₃-C₁₂ α-olefin comonomer in a first solvent. The first feed 110 may comprise a single phase feed comprising monomers fully dissolved in solvent or a dual phase feed comprising monomers dissolved in solvent and a gaseous phase.

The (solvent+comonomer) to ethylene ratio in the first feed 110 may be from 5 to 9, such as from 5 to 8, from 5 to 7, from 5 to 6, from 6 to 9, from 6 to 8, from 7 to 9, from 7 to 8, or any subset thereof. In embodiments where the first solution polymerization reactor 120 is a loop reactor, the (solvent+comonomer) to ethylene (S/E) ratio in the first feed 110 may be from 5 to 9, from 5 to 8, such as from 5 to 7, from 5 to 6, from 6 to 8, from 6 to 7, or from 7 to 8. In embodiments where the first solution polymerization reactor 120 is a CSTR, the (solvent+comonomer) to ethylene ratio in the first feed 110 may be from 5 to 9, such as from 5 to 8, from 7 to 9, from 7 to 8, or any subset thereof.

The method may comprise reacting the first ethylene monomer and optionally C₃-C₁₂ α-olefin comonomer in the first solvent in the presence of a first catalyst in a first solution polymerization reactor 120 to produce the first polymer fraction. At least 80 wt. %, at least 90 wt. %, at least 99 wt. %, or even at least 99.9 wt. % of the polymerizable compounds which contact the first catalyst in the presence of the ethylene monomer may be the ethylene monomer and the C₃-C₁₂ α-olefin comonomer.

The C₃-C₁₂ α-olefin comonomer may include, by way of example but not limitation, propylene, 1-butene, 1-pentene, 1-hexene, 4-methyl-1-pentene, 1-heptene, 1-decene and 1-octene, as well as other monomer types such as styrene, alkyl-substituted styrenes, vinyl benzocyclobutane, dienes such as 1,4-hexadiene, 1,7-octadiene, 1,9-decadiene, and ethylidene norbornene and cycloalkenes (e.g., cyclopentene, cyclohexene and cyclooctene).

The ratio of ethylene monomer and C₃-C₁₂ α-olefin comonomer fed to the first reactor may be from 0 to 49 mol. % of C₃-C₁₂ α-olefin comonomer, such as from 0 to 40 mol. %, from 0 to 30 mol. %, from 0 to 20 mol. %, from 0 to 10 mol. %, from 0 to 5 mol. %, from 0 to 1 mol. %, from 0 to 0.001 mol. %, from 1 to 49 mol. %, from 1 to 40 mol. %, from 1 to 30 mol. %, from 1 to 20 mol. %, from 1 to 10 mol. %, from 10 to 49 mol. %, from 10 to 40 mol. %, from 10 to 30 mol. %, from 10 to 20 mol. %, from 20 to 49 mol. %, from 20 to 30 mol. %, or any subset thereof, of C₃-C₁₂ α-olefin comonomer.

Various hydrocarbon solvents are considered suitable for use as the first solvent. For example, in one or more embodiments, the hydrocarbon solvent may comprise paraffinic, isoparaffinic, naphthenic, aromatic hydrocarbon solvent, aliphatic hydrocarbon solvent, or mixtures thereof. Specific solvents may include cyclohexane, hexane, heptane, octane, nonane, isooctane, ethylbenzene, isopentane, toluene or methyl isobutyl ketone (MBK).

### The First Reactor and Reactions

Reacting the first ethylene monomer and optionally C₃-C₁₂ α-olefin comonomer may occur in a first solution polymerization reactor 120. The first solution polymerization reactor 120 may be any solution reactor, such as at least one continuously stirred tank reactor (CSTR), at least one loop reactor, at least one tubular reactor, or combinations thereof.

The (solvent+comonomer) to ethylene ratio in the first solution polymerization reactor 120 may be from 5 to 9, such as from 5 to 8, from 5 to 7, from 5 to 6, from 6 to 9, from 6 to 8, from 7 to 9, from 7 to 8, or any subset thereof. In embodiments where the first solution polymerization reactor 120 is a loop reactor, the (solvent+comonomer) to ethylene (S/E) ratio in the first solution polymerization reactor 120 may be from 5 to 9, from 5 to 8, such as from 5 to 7, from 5 to 6, from 6 to 8, from 6 to 7, or from 7 to 8. In embodiments where the first solution polymerization reactor 120 is a CSTR, the (solvent+comonomer) to ethylene ratio in the first solution polymerization reactor 120 may be from 5 to 9, such as from 5 to 8, from 7 to 9, from 7 to 8, or any subset thereof.

The first catalyst may comprise Ziegler-Natta catalyst systems, single-site, and multi-site catalysts, including, but not limited to, bis-metallocene catalysts, constrained geometry catalysts, post-metallocene catalysts, molecular catalysts, bis-phenyl-phenoxy catalysts, and heterogeneous Ziegler Natta catalysts. For example, the first catalyst may comprise at least one molecular catalyst, at least one heterogeneous Ziegler-Natta catalyst, at least one metallocene catalyst, or combinations thereof. The at least one Ziegler-Natta catalyst may comprise titanium chlorides, magnesium chlorides, or both, and a support material such as amorphous silica. Exemplary catalysts are listed in Table 5.

The first solution polymerization reactor may operate at a pressure of from 10 bar to 450 bar. For example, the first solution polymerization reactor may operate at a pressure of from 10 bar to 45 bar, from 30 bar to 450 bar, from 13 bar to 30 bar, or any subset thereof.

The first solution polymerization reactor may have an exit temperature of at least 110° C. For example, the first solution polymerization reactor may have an exit temperature of at least 120° C., at least 130° C., at least 140° C., at least 150° C., at least 160° C., at least 170° C., at least 180° C., at least 190° C., at least 200° C., from 110° C. to 250° C., from 120° C. to 250° C., from 130° C. to 250° C., from 140° C. to 250° C., from 150° C. to 250° C., from 160° C. to 250° C., from 180° C. to 250° C., from 110° C. to 200° C., or any subset thereof.

The ethylene monomer may polymerize alone or in combination with the C₃-C₁₂ α-olefin comonomer to form the first polymer fraction. At least 70 wt. %, at least 75 wt. %, at least 80 wt. %, at least 85 wt. %, or even at least 88 wt. % of the ethylene monomer may polymerize to form the first polymer fraction.

### The First Polymer Fraction

Reacting the first ethylene monomer and optionally C₃-C₁₂ α-olefin comonomer in the first solvent in the presence of a first catalyst may produce first polymer fraction. The first polymer fraction may have a weight averaged molecular weight (Mw) of at least 30,000 g/mol. For example, the first polymer fraction may have a Mw of at least 40,000 g/mol, at least 50,000 g/mol, at least 60,000 g/mol, at least 75,000 g/mol, at least 100,000 g/mol, at least 200,000 g/mol, at least 300,000 g/mol, at least 400,000 g/mol, at least 500,000 g/mol, from 30,000 to 800,000 g/mol, from 50,000 to 800,000 g/mol, from 75,000 to 800,000 g/mol, from 100,000 to 800,000 g/mol, from 250,000 to 800,000 g/mol, from 500,000 to 800,000 g/mol, from 30,000 to 650,000 g/mol, from 30,000 to 500,000 g/mol, from 50,000 to 650,000 g/mol, from 100,000 to 500,000 g/mol, or any subset thereof. The Mw of the polymer compound may be determined by gel permeation chromatography, as described below.

The first polymer fraction may have a molecular weight distribution (Mw/Mn=MWD) of from 2 to 5. For example, the first polymer fraction may have a MWD of from 2 to 4.5, from 2 to 4, from 2 to 3, from 2 to 2.5, from 2.5 to 5, from 2.5 to 4.5, from 2.5 to 4, from 2.5 to 3, from 3 to 5, from 3 to 4.5, or any subset thereof.

The first polymer fraction may have a melt index (12) of at least 0.001 g/10 mins. For example, the melt index (12) of the first polymer fraction may be at least 0.01 g/10 mins, at least 0.1 g/10 mins, at least 1 g/10 mins, at least 2.01 g/10 mins, from 0.001 to 50 g/10 mins, from 0.001 to 25 g/10 mins, from 0.001 to 10 g/10 mins, from 0.001 to 5 g/10 mins, from 0.001 to 3 g/10 mins, from 0.001 to 1 g/10 mins, from 0.001 to 0.5 g/10 mins, from 0.001 to 0.3 g/10 mins, from 0.001 to 0.25 g/10 mins, from 0.001 to 0.2 g/10 mins, from 0.001 to 0.18 g/10 mins, from 0.001 to 0.17 g/10 mins, from 0.14 to 0.2 g/10 mins, from 0.14 to 0.18 g/10 mins, from 0.14 to 0.16 g/10 mins, from 0.16 to 0.2 g/10 mins, from 0.18 to 0.2 g/10 mins, or any subset thereof. The melt index of the first polymer fraction may be determined according to ASTM D1238, as described below.

The first polymer fraction may have a density of from 0.880 to 0.955 g/cm³. For example, the first polymer fraction may have a density of from 0.880 to 0.950 g/cm³, of from 0.880 to 0.945 g/cm³, of from 0.880 to 0.940 g/cm³, of from 0.880 to 0.935 g/cm³, of from 0.880 to 0.930 g/cm³, of from 0.880 to 0.925 g/cm³, of from 0.880 to 0.920 g/cm³, of from 0.880 to 0.915 g/cm³, of from 0.880 to 0.910 g/cm³, of from 0.880 to 0.905 g/cm³, of from 0.890 to 0.955 g/cm³, of from 0.900 to 0.955 g/cm³, of from 0.910 to 0.955 g/cm³, of from 0.920 to 0.955 g/cm³, of from 0.930 to 0.955 g/cm³, of from 0.940 to 0.955 g/cm³, of from 0.890 to 0.940 g/cm³, of from 0.900 to 0.930 g/cm³, of from 0.910 to 0.920 g/cm³, or any subset thereof

The first polymer fraction may be contained within a first polymer solution effluent 130. The first polymer solution effluent 130 may be at least 10 wt. % polymer solids. For example, the first polymer solution effluent 130 may be from 10 to 22 wt. % solids, from 10 to 20 wt. %, from 10 to 16 wt. %, from 10 to 14 wt. %, from 10 to 13 wt. %, from 10 to 12 wt. %, from 18 to 20 wt. %, or any subset thereof, of polymer solids. The amount of polymer solids in the first polymer solution effluent 130 may be at least partially determined by the choice of reactor. Accordingly, when the first solution polymerization reactor 120 is a CSTR, the first polymer solution effluent 130 may be from 10 to 16 wt. %, from 10 to 14 wt. %, or from 10 to 13 wt. %, from 11 to 13 wt. %, from 10 to 12.9 wt. %, or any subset thereof, of polymer solids. When the first solution polymerization reactor 120 is a loop reactor, the first polymer solution effluent 130 may be from 18 to 20 wt. %, or from 18 to 19 wt. % polymer, or any subset thereof, of polymer solids.

### The Second Feed

The method may further comprise reacting the first polymer fraction, a second catalyst, and a second feed 140 comprising ethylene monomer, optionally C₃-C₁₂ α-olefin comonomer, and optionally hydrogen in a second solution polymerization reactor 150 to produce a second polymer fraction. The second polymer fraction may be contained within an effluent 160.

The second feed 140 may be a single-phase. For example, the second feed 140 may be a gaseous or supercritical phase, which comprises the ethylene monomer and the optional C₃-C₁₂ α-olefin comonomer.

The second feed 140 may comprise ethylene monomer, optionally C₃-C₁₂ α-olefin comonomer, and optionally hydrogen. For example, the second feed 140 may comprise at least 50 wt. %, at least 75 wt. %, at least 90 wt. %, at least 95 wt. %, at least 99 wt. %, or even at least 99.9 wt. % of the combined weight of ethylene monomer, C₃-C₁₂ α-olefin comonomer, and hydrogen.

The second feed 140 may be substantially free of solvent. For example, the second feed 140 may comprise less than 0.1 wt. %, less than 0.01 wt. %, less than 0.001 wt. %, less than 0.0001 wt. %, or even 0 wt. % of solvent. It should be understood that the second feed 140 may refer to all compounds which are fed to the inlet of the second solution polymerization reactor 150. However, the second feed does not include solvent which may pass through a reactor pump, such as through pump seals.

The second feed 140 may be substantially free of co-monomer, such as the C₃-C₁₂ α-olefin comonomer. For example, the second feed 140 may comprise less than 5 wt. %, less than 1 wt. %, less than 0.1 wt. %, less than 0.01 wt. %, less than 0.001 wt. %, less than 0.0001 wt. %, or even 0 wt. % of comonomer.

The ratio of ethylene monomer and C₃-C₁₂ α-olefin comonomer fed to the second solution polymerization reactor 150 may be from 0 to 49 mol. % of C₃-C₁₂ α-olefin comonomer, such as from 0 to 40 mol. %, from 0 to 30 mol. %, from 0 to 20 mol. %, from 0 to 10 mol. %, from 0 to 5 mol. %, from 0 to 1 mol. %, from 0 to 0.001 mol. %, from 1 to 49 mol. %, from 1 to 40 mol. %, from 1 to 30 mol. %, from 1 to 20 mol. %, from 1 to 10 mol. %, from 10 to 49 mol. %, from 10 to 40 mol. %, from 10 to 30 mol. %, from 10 to 20 mol. %, from 20 to 49 mol. %, from 20 to 30 mol. %, or any subset thereof, of C₃-C₁₂ α-olefin comonomer.

The second feed 140 may comprise less than 1.5 mole % (mol. %) hydrogen. For example, the second feed may comprise from 0.5 to 1.5 mol. %, from 0.5 to 1.25 mol. %, from 0.5 to 1.0 mol. %, from 0.75 to 1.5 mol. %, from 0.75 to 1.25 mol. %, from 0.75 to 1.0 mol. %, less than 1.25 mol. %, less than 1.0 mol. %, less than 0.75 mol. %, less than 0.5 mol. %, or even less than 0.1 mol. % hydrogen.

### The Second Reactor and Reactions

The method may comprise reacting the first polymer fraction, a second catalyst, and a second feed 140 comprising ethylene monomer, optionally C₃-C₁₂ α-olefin comonomer, and optionally hydrogen in a second solution polymerization reactor 150.

The second catalyst may comprise Ziegler-Natta catalyst systems, single-site, and multi-site catalysts, including, but not limited to, bis-metallocene catalysts, constrained geometry catalysts, post-metallocene catalysts, molecular catalysts, bis-phenyl-phenoxy catalysts, and heterogeneous Ziegler Natta catalysts. For example, the second catalyst may comprise at least one molecular catalyst, at least one heterogeneous Ziegler-Natta catalyst, at least one metallocene catalyst, or combinations thereof. The at least one Ziegler-Natta catalyst may comprise titanium chlorides, magnesium chlorides, or both, and a support material such as amorphous silica. The at least one metallocene catalyst may comprise organic ligands such as cyclopentadienyl, chlorine, and a metal such as Ti, Zn, or Hf.

In some embodiments, the first catalyst and the second catalyst may comprise different compositions. For example, the first catalyst may comprise a homogenous molecular catalyst and one or more co-catalysts. The second catalyst may comprise a heterogeneous Ziegler-Natta catalyst comprising titanium chlorides.

The second solution polymerization reactor 150 may comprise at least one continuous stirred tank reactor (CSTR), at least one loop reactor, at least one tubular reactor, or combinations thereof. In some embodiments, the second solution polymerization reactor comprises a loop reactor. The second solution polymerization reactor 150 may operate at a pressure of from 10 bar to 450 bar. For example, the second solution polymerization reactor 150 may operate at a pressure of from 10 bar to 45 bar, from 30 bar to 450 bar, from 13 bar to 30 bar, or any subset thereof. The feed temperature for the second solution polymerization reactor may be maintained at less than 45° C.

The second solution polymerization reactor 150 may reach an exit temperature of at least 110° C. For example, the second solution polymerization reactor 150 may reach an exit temperature of at least 110° C., at least 120° C., at least 130° C., at least 140° C., at least 150° C., at least 160° C., at least 170° C., at least 180° C., at least 190° C., or at least 195° C., from 110° C. to 225° C., from 150° C. to 225° C., from 160° C. to 225° C., from 180° C. to 225° C., from 190° C. to 225° C., from 195° C. to 225° C., from 150° C. to 200° C., from 160° C. to 200° C., from 170° C. to 200° C., or from 180° C. to 200° C.

According to some embodiments, the only solvent which enters the second solution polymerization reactor 150 may be that which is in solution with the first polymer fraction. Specifically, at least 90 wt. %, at least 95 wt. %, at least 99 wt. %, at least 99.9 wt. %, at least 99.99 wt. %, at least 99.999 wt. %, or even at least 100 wt. % of the solvent which enters the second solution polymerization reactor 150 may have been present in the first solution polymerization reactor 120.

It should be understood that in some embodiments relatively small amounts of solvent may be provided to the second solution polymerization reactor 150. In such embodiments, the solvent may be provided away from the second feed 140 to the second solution polymerization reactor 150, such as at/through the pumps. This may result in feeding an overall, outside of that provided by the effluent from the first solution polymerization reactor 120, (solvent+comonomer) to ethylene ratio of less than 0.3, less than 0.25, less than 0.2, less than 0.1, less than 0.01, less than 0.001, less than 0.00001, from 0.001 to 0.3, from 0.001 to 0.2, from 0.01 to 0.3, from 0.01 to 0.2, from 0.1 to 0.3, from 0.1 to 0.2, from 0.2 to 0.3, or any subset thereof.

### The Second Polymer Fraction

Reacting the first polymer fraction, the second catalyst, and the second feed in the second solution polymerization reactor 150 may produce a second polymer fraction. It should be understood that the second polymer fraction may be in solution or otherwise mixed with the first polymer fraction.

The second polymer fraction may have a weight averaged molecular weight (Mw) of from 5,000 g/mol to 200,000 g/mol, such as from 10,000 g/mol to 200,000 g/mol, from 25,000 g/mol to 200,000 g/mol, from 50,000 g/mol to 200,000 g/mol, from 75,000 g/mol to 200,000 g/mol, from 100,000 g/mol to 200,000 g/mol, from 150,000 g/mol to 200,000 g/mol, from 5,000 g/mol to 150,000 g/mol, from 5,000 g/mol to 100,000 g/mol, from 5,000 g/mol to 75,000 g/mol, from 5,000 g/mol to 50,000 g/mol, from 25,000 g/mol to 175,000 g/mol, from 50,000 g/mol to 150,000 g/mol, or any subset thereof.

The second polymer fraction may have a molecular weight distribution (MWD) of from 2.0 to 5.0, such as from 2.0 to 4.0, from 2.0 to 3.0, from 3.0 to 5.0, from 4.0 to 5.0, or any subset thereof.

The second polymer fraction may have a density of from 0.900 g/cc to 0.980 g/cc. For example, the second polymer fraction may have a density of from 0.925 g/cc to 0.980 g/cc, from 0.950 g/cc to 0.980 g/cc, from 0.900 g/cc to 0.950 g/cc, from 0.900 g/cc to 0.925 g/cc, from 0.925 g/cc to 0.965 g/cc, or any subset thereof.

### The Third Reactor

The systems and methods of the present disclosure may comprise further polymerization reactors downstream of the first solution polymerization reactor 120 and the second solution polymerization reactor 150. These reactors may be loop reactors, continuous stirred tank reactors, pipe flow reactors, tubular reactors, or combinations thereof. For example, the systems and methods of the present disclosure may comprise a third solution polymerization reactor downstream of the second solution polymerization reactor 150. The third reactor may comprise a tubular reactor, such as a plug flow reactor.

The primary feed to the third solution polymerization reactor may be the effluent 160 from the second solution polymerization reactor. In some embodiments, no feed may be provided to the third reactor, other than the effluent 160 from the second solution polymerization reactor 150. In such embodiments, the third reactor provides a space for the reaction initiated in the second solution polymerization reactor 150 to continue, effectively increasing its residence time. In such embodiments, a catalyst kill agent may not be introduced after the second solution polymerization reactor 150.

In alternate embodiments, catalyst, such as the second catalyst or a separate third catalyst, may be provided to the third reactor but no additional monomer may be provided. In yet still other embodiments, the methods of the present disclosure may comprise contacting the first and second polymer fractions with a third catalyst, and a third feed comprising ethylene monomer, optionally C₃-C₁₂ α-olefin comonomer, and optionally hydrogen in a third solution polymerization reactor to produce a third polymer fraction.

The exit temperature of the third reactor may be at least 110° C., at least 120° C., at least 130° C., at least 140° C., at least 150° C., at least 160° C., at least 170 180° C., at least 190° C., at least 200° C., from 110° C. to 220° C., from 160° C. to 220° C., from 180 to 220° C., from 190 to 210° C., from 200 to 210° C., or any subset thereof. The exit temperature of the third reactor may be at least 5° C., at least 10° C., from 0 to 20° C., from 5 to 15° C., or any subset thereof, greater than the exit temperature of the second solution polymerization reactor 150.

In some embodiments, substantially no additional solvent is provided to the third reactor. Specifically, at least 90 wt. %, at least 95 wt. %, at least 99 wt. %, at least 99.9 wt. %, at least 99.99 wt. %, at least 99.999 wt. %, or even 100 wt. % of the solvent which enters the third polymerization reactor may have been present in the second polymerization reactor.

A mixer may be provided downstream of the second or third reactors. The mixer may be any mixer suitable for mixing polymers, such as an extruder. The mixer introduce a catalyst kill agent into the polymer.

### The Ethylene-Based Polymer

The method may further comprise outputting effluent 160 from the second solution polymerization reactor 150. The effluent 160 may comprise the ethylene-based polymer having the first and second polymer fractions.

In embodiments with a third solution polymerization reactor, the method may further comprise outputting effluent from the third solution polymerization reactor. In such embodiments, the effluent may comprise the ethylene-based polymer having the first and second polymer fractions.

The ethylene-based polymer may have a melt index (I₂) from 0.1 to 100.0 g/10 mins. For example, the ethylene-based polymer may have a melt index (I₂) of from 0.1 to 90.0 g/10 mins, from 0.1 to 75 g/10 mins, from 0.1 to 50 g/10 mins, from 0.1 to 25 g/10 mins, from 0.1 to 10 g/10 mins, from 0.1 to 2 g/10 mins, from 0.1 to 1 g/10 mins, from 0.1 to 0.9 g/10 mins, from 0.1 to 0.8 g/10 mins, from 0.25 to 100 g/10 mins, from 0.25 to 50 g/10 mins, from 0.25 to 25 g/10 mins, from 0.25 to 10 g/10 mins, from 0.25 to 2 g/10 mins, from 0.25 to 1 g/10 mins, from 0.25 to 0.8 g/10 mins, from 0.7 to 100 g/10 mins, from 0.7 to 25 g/10 mins, from 0.7 to 10 g/10 mins, from 0.7 to 1 g/10 mins, from 0.7 to 0.8 g/10 mins, from 0.7 to 0.76, or any subset thereof. As described below, the melt index (12) may be measured according to standard test method ASTM D 1238.

The ethylene-based polymer may have a density from 0.900 to 0.975 g/cc. For example, the ethylene-based polymer may have a density from 0.925 to 0.975 g/cc, from 0.950 to 0.975 g/cc, from 0.900 to 9.950 g/cc, from 0.900 to 0.925 g/cc, or any subset thereof.

The ethylene-based polymer may have a melt index ratio (I₂₁/I₂) ratio from 20 to 500. For example, the ethylene-based polymer may have an I₂₁/I₂ ratio from 20 to 400, from 20 to 300, from 20 to 250, from 20 to 200, from 20 to 150, from 20 to 100, from 20 to 75, from 20 to 50, from 30 to 500, from 30 to 350, from 30 to 250, from 30 to 200, from 30 to 150, from 30 to 100, from 30 to 75, from 40 to 500, from 40 to 250, from 40 to 200, from 40 to 100, from 60 to 500, from 60 to 200, from 60 to 150, from 60 to 100, from 80 to 500, from 80 to 250, from 80 to 200, from 80 to 150, or any subset thereof. As described below, the melt index (I₂ and I₂₁) may be measured according to standard test method ASTM D 1238. Without being limited by theory, the ratio of I₂₁/I₂ describes the processability of the polymers, with increasing numbers resulting in easier processing.

The ethylene-based polymer may have a melt index ratio (I₁₀/I₂) of from 5.5 to 30. For example, the ethylene-based polymer may have a melt index ratio (I₁₀/I₂) of from 5.5 to 25, from 5.5 to 20, from 5.5 to 15, from 5.5 to 10, from 10 to 30, from 10 to 20, or any subset thereof. As described below, the melt index (I₂ and I₁₀) may be measured according to standard test method ASTM D 1238.

The ethylene-based polymer may have a molecular weight distribution MWD from 2.5 to 40. For example, the ethylene-based polymer may have a MWD of from 2.5 to 30, from 2.5 to 25, from 2.5 to 20, from 2.5 to 15, from 2.5 to 10, from 2.5 to 8, from 5 to 30, from 5 to 25, from 5 to 20, from 5 to 15, from 6.8 to 10, from 6.8 to 9, from 6.8 to 8.7, from 7 to 11, from 7 to 9, or any subset thereof.

### Test Methods

### Density

Samples for density measurement are prepared according to ASTM D 1928. Polymer samples are pressed at 190° C. and 30,000 psi for three minutes, and then at 21° C. and 207 MPa for one minute. Measurements are made within one hour of sample pressing using ASTM D792, Method B.

### Melt Index (I₂)

Melt index, or I₂, (grams/10 minutes or dg/min) is measured in accordance with ASTM D 1238, Condition 190° C./2.16 kg, Procedure B.

### Melt Index (I₁₀)

Melt index, or I₁₀, (grams/10 minutes or dg/min) is measured in accordance with ASTM D 1238, Condition 190° C./10 kg, Procedure B.

### Melt Index (I₂₁)

Melt index, or I₂₁, (grams/10 minutes or dg/min) is measured in accordance with ASTM D 1238, Condition 190° C./21.6 kg, Procedure B.

### Number and Weight Averaged Molecular Weight (Mn)

The Mn and Mw are measured by gel permeation chromatography (GPC).

### Gel Permeation Chromatography (GPC)

GPC was performed on a PolymerChar GPC-IR (Valencia, Spain) high temperature GPC chromatograph equipped with an internal IR5 infra-red detector (IR5). The autosampler oven compartment was set at 160° Celsius and the column compartment was set at 150° Celsius. The columns used were 4 “Mixed A” 30 cm 20-micron linear mixed-bed columns (purchased from Agilent Technologies, Inc.). The chromatographic solvent used was 1,2,4 trichlorobenzene and contained 200 ppm of butylated hydroxytoluene (BHT). The solvent source was nitrogen sparged. The injection volume used was 200 microliters and the flow rate was 1.0 milliliters/minute.

Calibration of the GPC column set was performed with 21 narrow molecular weight distribution polystyrene standards with molecular weights ranging from 580 g/mol to 8,400,000 g/mol and were arranged in 6 “cocktail” mixtures with at least a decade of separation between individual molecular weights. The standards were purchased from Agilent Technologies, Inc. The polystyrene standards were prepared at 0.025 grams in 50 milliliters of solvent for molecular weights equal to or greater than 1,000,000, and 0.05 grams in 50 milliliters of solvent for molecular weights less than 1,000,000. The polystyrene standards were pre-dissolved at 80° C. with gentle agitation for 30 minutes then cooled and the room temperature solution is transferred cooled into the autosampler dissolution oven at 160° C. for 30 minutes. The polystyrene standard peak molecular weights were converted to polyethylene molecular weights using Equation 1 (as described in Williams and Ward, J. Polym. Sci., Polym. Let., 6, 621 (1968)):

M_{polyethylene}=A×(M_{polystyrene})^{B} (EQ1)

where M is the molecular weight, A has a value of 0.4315 and B is equal to 1.0.

A fifth order polynomial was used to fit the respective polyethylene-equivalent calibration points.

The total plate count of the GPC column set was performed with decane which was introduced into blank sample via a micropump controlled with the PolymerChar GPC-IR system. The plate count for the chromatographic system should be greater than 18,000 for the 4 “Mixed A” 30 cm 20-micron linear mixed-bed columns (from Agilent Technologies, Inc.).

Samples were prepared in a semi-automatic manner with the PolymerChar “Instrument Control” Software, wherein the samples were weight-targeted at 2 mg/ml, and the solvent (contained 200 ppm BHT) was added to a pre nitrogen-sparged septa-capped vial, via the PolymerChar high temperature autosampler. The samples were dissolved for 2 hours at 160° Celsius under “low speed” shaking.

The calculations of Mn(GPC), Mw(GPC), and Mz(GPC) were based on GPC results using the internal IR5 detector (measurement channel) of the PolymerChar GPC-IR chromatograph according to Equations 2-4, using PolymerChar GPCOne™ software, the baseline-subtracted IR chromatogram at each equally-spaced data collection point (i), and the polyethylene equivalent molecular weight obtained from the narrow standard calibration curve for the point (i) from Equation 1.

$${Mn}_{( GPC )} = \frac{{\sum }^{i} {IR}_{i}}{{\sum }^{i} ( {IR}_{i} / {M}_{{polyethylene}_{i}} )} \qquad ( EQ 2 )$$

$${Mw}_{( GPC )} = \frac{{\sum }^{i} ( {IR}_{i} * {M}_{{polyethylene}_{i}} )}{{\sum }^{i} {IR}_{i}} \qquad ( EQ 3 )$$

$${Mz}_{( GPC )} = \frac{{\sum }^{i} ( {IR}_{i} * {M}_{{polyethylene}_{i}}^{2} )}{{\sum }^{i} ( {IR}_{i} * {M}_{{polyethylene}_{i}} )} \qquad ( EQ 4 )$$

In order to monitor the deviations over time, a flowrate marker (decane) was introduced into each sample via a micropump controlled with the PolymerChar GPC-IR system. This flowrate marker (FM) was used to linearly correct the pump flowrate (Flowrate (nominal)) for each sample by RV alignment of the respective decane peak within the sample (RV(FM Sample)) to that of the decane peak within the narrow standards calibration (RV(FM Calibrated)). Any changes in the time of the decane marker peak are then assumed to be related to a linear-shift in flowrate (Flowrate(effective)) for the entire run. After calibrating the system based on a flow marker peak, the effective flowrate (with respect to the narrow standards calibration) is calculated as Equation 5. Processing of the flow marker peak was done via the PolymerChar GPCOne™ Software. Acceptable flowrate correction is such that the effective flowrate should be within +/−0.5% of the nominal flowrate.

$$Flowrate ( effective ) = \frac{Flowrate ( nominal ) * ( RV * ( FM Calibrated )}{RV ( FM Sample )} \qquad ( EQ 5 )$$

$$Flowrate ( effective ) = Flowrate ( nominal ) * ( RV ( FM Calibrated ) / RV ( FM Sample ) )$$

### EXAMPLES

Embodiments will be further clarified by the following examples.

A series of simulations were prepared according to the conditions specified in Tables 1-3. The simulated system used three reactors in series. Reactor one was a CSTR. Reactor two was a loop reactor. Reactor 3 was a plug flow reactor.

Table 1 gives the conditions for the first reactor, Table 2 gives the conditions for the second reactor, and Table 3 gives conditions for the third reactor. Comparative Examples are labelled CE and Inventive Examples are labeled IE. In each of IE1-4 and CE1-4, the first reactor comonomer was 1-octene. Table 4 shows the overall product exiting the third reactor, or if no third reactor is present, the second reactor.

TABLE 1
1^{st} Reactor

| | CE1 | IEI | CE2 | IE2 | CE3 | IE3 | CE4 | IE4 | CE5 | IE5 |
|---|---|---|---|---|---|---|---|---|---|---|
| Feed Temp (°C) | 15 | 15 | 15 | 15 | 25 | 25 | 24.8 | 24.8 | 45 | 45 |
| Outlet Temp (°C) | 160 | 160 | 175 | 175 | 140 | 140 | 180 | 180 | 155 | 155 |
| Catalyst | Cat-1 | Cat-1 | Cat-3 | Cat-3 | Cat-4 | Cat-4 | Cat-3 | Cat-3 | Cat-5 | Cat-5 |
| Co-Catalyst A | Co- | Co- | Co- | Co- | Co- | Co- | Co- | Co- | Co- | Co- |
| | cat 1 | cat 1 | cat 1 | cat 1 | cat 1 | cat 1 | cat 1 | cat 1 | cat 1 | cat 1 |
| Co-Cat B | Co- | Co- | Co- | Co- | Co- | Co- | Co- | Co- | Co- | Co- |
| | cat 3 | cat 3 | cat 3 | cat 3 | cat 3 | cat 3 | cat 3 | cat 3 | cat 3 | cat 3 |
| (Solvent + | 8 | 8 | 7.5 | 7.5 | 6.4 | 8 | 8 | 8 | 7.2 | 8 |
| Comonomer)/ | | | | | | | | | | |
| Ethylene Wt. Ratio | | | | | | | | | | |
| Polymer | 12.11 | 12.11 | 11.31 | 11.31 | 10.7 | 10.7 | 12.65 | 12.9 | 8.3 | 7.19 |
| Concentration (wt. | | | | | | | | | | |
| %) | | | | | | | | | | |

TABLE 2
2^{nd} Reactor

| | CE1 | IE1 | CE2 | IE2 | CE3 | IE3 | CE4 | IE4 | CE5 | IE5 |
|---|---|---|---|---|---|---|---|---|---|---|
| Feed Temp (°C) | 40 | 40 | 40 | 40 | 40 | 40 | 36 | 36 | 40 | 40 |
| Reactor Temp | 195 | 195 | 190 | 190 | 195 | 195 | 190 | 190 | 205 | 205 |
| (°C) | | | | | | | | | | |
| Reactor Catalyst | Cat-2 | Cat-2 | Cat-2 | Cat-2 | Cat-2 | Cat-2 | Cat-3 | Cat-3 | Cat-6 | Cat-6 |
| Co-Catalyst A | Co- | Co- | Co- | Co- | Co- | Co- | Co- | Co- | Co- | Co- |
| | Cat 2 | Cat 2 | Cat 2 | Cat 2 | Cat 2 | Cat 2 | cat 1 | cat 1 | Cat 1 | Cat 1 |
| Co-Catalyst B | N/A | N/A | N/A | N/A | N/A | N/A | Co- | Co- | Co- | Co- |
| | | | | | | | cat 3 | cat 3 | cat 3 | cat 3 |
| (Solvent + | 2 | 0 | 2 | 0 | 3.2 | 0 | 2.2 | 0 | 1.65 | 0 |
| Comonomer)/ | | | | | | | | | | |
| Ethylene Wt. | | | | | | | | | | |
| Ratio | | | | | | | | | | |
| Pressure (psig) | 725 | 725 | 725 | 725 | 725 | 725 | 725 | 725 | 525 | 525 |
| Polymer | 15.83 | 19.55 | 15.89 | 17.95 | 15.72 | 16.27 | 17.78 | 22.41 | 17.68 | 18.25 |
| Concentration | | | | | | | | | | |
| (wt. %) | | | | | | | | | | |

TABLE 3
3^{rd} Reactor

| | CE1 | IE1 | CE2 | IE2 | CE3 | IE3 | CE4 | IE4 | CE5 | IE5 |
|---|---|---|---|---|---|---|---|---|---|---|
| Reactor | 207 | 207 | 197 | 197 | N/A | N/A | 195 | 195 | 206 | 206 |
| Temperature | | | | | | | | | | |
| Catalyst | Cat-2 | Cat-2 | Cat-2 | Cat-2 | N/A | N/A | Cat-3 | Cat-3 | Cat-6 | Cat-6 |
| Co-Catalyst A | Co- | Co- | Co- | Co- | N/A | N/A | Co- | Co- | Co- | Co- |
| | Cat 2 | Cat 2 | Cat 2 | Cat 2 | | | Cat 1 | Cat 1 | Cat 1 | Cat 1 |
| Co-Catalyst B | N/A | N/A | N/A | N/A | N/A | N/A | Co- | Co- | Co- | Co- |
| | | | | | | | Cat 3 | Cat 3 | Cat 3 | Cat 3 |
| Feed | N/A | N/A | N/A | N/A | N/A | N/A | N/A | N/A | N/A | N/A |

TABLE 4
Overall Polymer Production

| | CE1 | IE1 | CE2 | IE2 | CE3 | IE3 | CE4 | IE4 | CE5 | IE5 |
|---|---|---|---|---|---|---|---|---|---|---|
| Overall Polymer | 16.84 | 20.54 | 16.56 | 18.61 | 15.72 | 16.27 | 18.54 | 23.15 | 17.76 | 18.61 |
| Concentration (wt. | | | | | | | | | | |
| %) | | | | | | | | | | |
| Production Rate | 0 | 5.06 | 0 | 3.68 | 0 | 3.5 | 0 | 3.3 | 0 | 0.48 |
| Change % vs Design | | | | | | | | | | |
| Capacity (%) | | | | | | | | | | |
| Overall Melt Index | 0.85 | 0.85 | 21.5 | 21.5 | 0.55 | 0.55 | 0.85 | 0.85 | 1.2 | 1.2 |
| (I₂) (g/10 mins) | | | | | | | | | | |
| Overall Density (g/cc) | 0.918 | 0.918 | 0.907 | 0.907 | 0.941 | 0.941 | 0.902 | 0.902 | 0.966 | 0.966 |

TABLE 5
Catalysts

| Catalyst Code | Catalyst |
|---|---|
| Cat-1 | 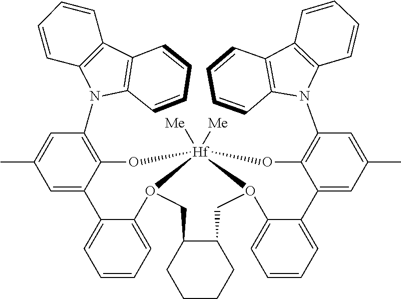 |
| Cat-2 | The second catalyst system comprised a heterogeneous Ziegler-Natta type |
| | catalyst. The catalyst-premix was prepared according to U.S. Pat. No. 4,612,300. |
| Cat-3 | 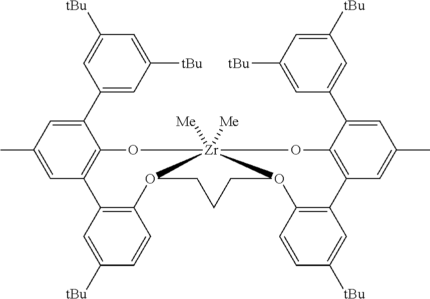 |
| Cat-4 | 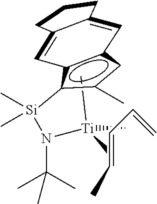 |
| Cat-5 | 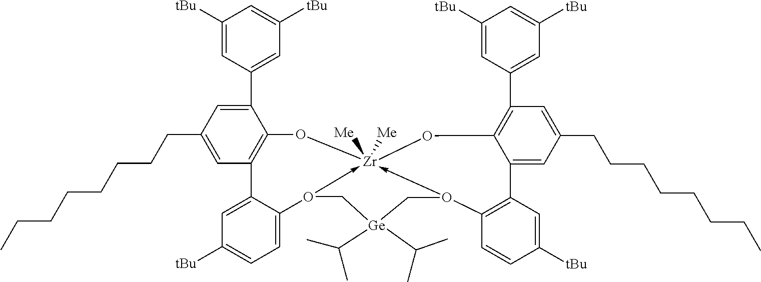 |
| | Chemical Formula: C₈₆H₁₂₈GeO₄Zr |
| Cat-6 | 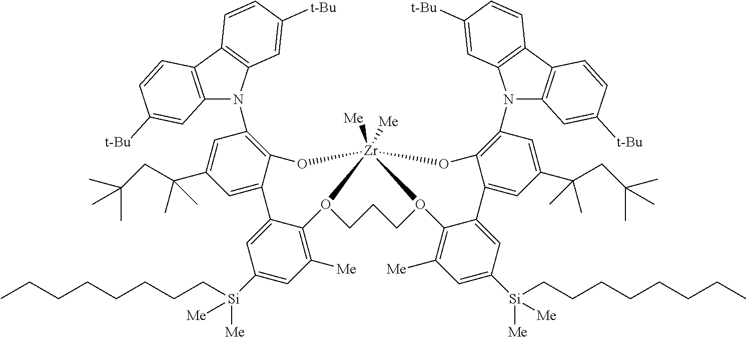 |
| Co-Cat 1 | R₂MeNH⁺ (R = hydrogenated tallow alkyl) |
| | 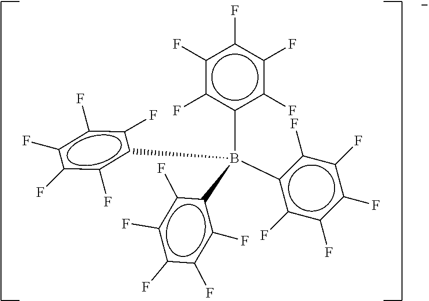 |
| Co-Cat 2 | Tri-ethyl aluminum |
| Co-Cat 3 | modified methylalumoxane |

Table 4, above, gives data on the overall polymer production process. As can be seen from Table 4, the Inventive Examples show a marked increase in production rate above their design capacity, while maintaining the same overall density and melt index characteristics as the Comparative Examples.

It will be apparent to those skilled in the art that various modifications and variations can be made to the embodiments described herein without departing from the spirit and scope of the claimed subject matter. Thus, it is intended that the specification cover the modifications and variations of the various embodiments described herein provided such modification and variations come within the scope of the appended claims and their equivalents.

1. A method of producing ethylene-based polymer comprising first and second polymer fractions comprises:
reacting ethylene monomer and optionally C₃-C₁₂ α-olefin comonomer in a first solvent in the presence of a first catalyst in a first solution polymerization reactor to produce the first polymer fraction;
reacting the first polymer fraction, a second catalyst, and a second feed comprising ethylene monomer, optionally C₃-C₁₂ α-olefin comonomer, and optionally hydrogen in a second solution polymerization reactor to produce a second polymer fraction, wherein the second feed is substantially free of solvent; and
outputting effluent from the second solution polymerization reactor, wherein the effluent comprises the ethylene-based polymer having the first and second polymer fractions.

2. The method of claim 1, wherein the ethylene-based polymer has a melt index (I₂) from 0.1 to 100.0 g/10 mins.

3. The method of claim 1, wherein a weight averaged molecular weight (Mw) of the first polymer fraction is larger than 30,000 g/mol.

4. The method of claim 1, wherein the ethylene-based polymer has a density between 0.900 to 0.975 g/cc.

5. The method of claim 1, wherein the ethylene-based polymer has an I₂₁/I₂ ratio from 20 to 500.

6. The method of claim 1, wherein the ethylene-based polymer has a molecular weight distribution (MWD=Mw/Mn) from 2.5 to 40.

7. The method of claim 1, wherein the first solution polymerization reactor, the second solution polymerization reactor, or both comprises at least one continuous stirred tank reactor (CSTR), at least one loop reactor, at least one tubular reactor, or combinations thereof.

8. The method of claim 1, wherein the second solution polymerization reactor comprises a loop reactor.

9. The method of claim 1, wherein the first catalyst, the second catalyst, or both comprise at least one molecular catalyst, at least one heterogeneous Ziegler-Natta catalyst, at least one metallocene catalyst, or combinations thereof.

10. The method of claim 1, further comprising a third reactor downstream of the second solution polymerization reactor.

11. The method of claim 10, wherein the third reactor comprises a tubular reactor.

12. The method of claim 10, wherein substantially no additional solvent is provided to the third reactor.

13. The method of claim 1, wherein the first catalyst and the second catalysts each comprise different compositions.

14. The method of claim 1, wherein the first solution polymerization reactor has an exit temperature of at least 110° C.

15. The method of claim 1, wherein the first solution polymerization reactor has an exit temperature of at least 160° C.

16. The method of claim 1, wherein the first catalyst comprises a molecular catalyst.

17. The method of claim 1 wherein the feed temperature for the second solution polymerization reactor is maintained at less than 45° C.

18. The ethylene-based polymer produced from the method of claim 1.
